(19) United States
(12) Patent Application Publication
(10) Pub. No.: US 2026/0035577 A1
(43) Pub. Date: Feb. 5, 2026

(54) THERMALLY CONDUCTIVE POTTING MATERIALS

(71) Applicant: Henkel AG & Co. KGaA, Duesseldorf (DE)

(72) Inventors: Bradley D. Seurer, Chaska, MN (US); Radesh Jewram, Lakeville, MN (US)

(21) Appl. No.: 19/354,884

(22) Filed: Oct. 10, 2025

Related U.S. Application Data
(63) Continuation-in-part of application No. PCT/US2024/023810, filed on Apr. 10, 2024.
(60) Provisional application No. 63/458,200, filed on Apr. 10, 2023.

(51) Int. Cl. C09D 5/18; C08K 3/22; C08K 3/28; C09D 7/40; C09D 7/61; C09D 183/04; C09K 5/14

(52) U.S. Cl. CPC C09D 5/18; C09D 7/61; C09D 7/69; C09D 183/04; C09K 5/14; C08K 2003/2227; C08K 2003/282; C08K 2201/001; C08K 2201/005; C08K 2201/014

(57) ABSTRACT

A thermally conductive silicone-based potting composition is provided that exhibits a thermal conductivity of at least 3 W/m*K and a low viscosity across a shear range. The composition is dispensable and curable to a form-stable condition.

### FIELD OF THE INVENTION

The present invention relates to thermally conductive materials generally, and more particularly to a thermally conductive potting material that may be formed in place following dispensation from a vessel. The thermally conductive potting material includes a silicone resin matrix loaded with thermally conductive filler, yet exhibits flowability properties that permit the material to be used as a heat-dissipating potting composition for electrical or electronic devices.

### BACKGROUND OF THE INVENTION

Thermally conductive materials are widely employed for the purpose of dissipating excess heat from heat-generating electronic components such as semiconductor elements, power transistors, integrated circuits, and battery elements. Thermally conductive greases, gels, pastes, and sheets have been used as interfaces between heat-dissipating elements such as plates and fins, and the heat-generating components. However, such thermally conductive material forms are often difficult to handle, difficult to dispense, and/or difficult to shape appropriately to maximize heat transfer efficiency.

To address these issues, liquid silicone compositions have been employed as a dispensable base matrix for carrying thermally conductive filler. The compositions may be curable as form in place potting materials that can effectively dissipate excess heat. Conventional potting materials, however, are typically either insufficiently thermally conductive to effectively dissipate heat from modern high-power electronic components, or exhibit an excessive viscosity that prevents uniform and thorough application within the heat dissipation pathway.

There is accordingly a need to provide a thermally conductive potting composition that exhibits high thermal conductivity and sufficiently low viscosity to maintain good flowability for dispensation and positioning for use as a potting material. It is further an object of the invention that the potting material maintain desirable properties subsequent to cure.

It is another object of the present invention to provide a thermally conductive silicone composition that has a high thermal conductivity and desirable dispensability and workability due to a low viscosity over a range of shear.

### SUMMARY OF THE INVENTION

By means of the present invention, a highly thermally conductive silicone-based material may be provided as a low-viscosity dispensable composition. The composition may be useful as a potting material for securing heat-generating electronic components to and along a thermal dissipation pathway. The composition utilizes a highly filled silicone matrix that nevertheless exhibits good self-leveling properties useful for potting applications.

One embodiment of the present invention includes a thermally conductive potting material having a liquid silicone resin and thermally conductive particulate filler dispersed in the liquid silicone resin in an amount of at least 90 wt. % of the potting material, wherein the potting material exhibits a thermal conductivity of at least 3 W/m*K. The potting material preferably further exhibits a viscosity of less than 500 Pa*s at a first shear rate of 0.1 s⁻¹ and at 25° C., and a viscosity of less than 50 Pa*s at a second shear rate of 1 s⁻¹ and at 25° C.

In some embodiments, the thermally conductive potting material exhibits a viscosity of less than 50 Pa*s at a third shear rate of 0.5 s⁻¹ and at 25° C. The thermally conductive material may further exhibit a change in viscosity (Δρ) of less than 100 Pa*s between the first and second shear rates at 25° C.

The thermally conductive potting material may exhibit essentially zero critical stress, and the liquid silicone resin may exhibit a viscosity of less than 500 cP at a shear rate of 1 s⁻¹ at 25° C.

In some embodiments, the thermally conductive potting material may exhibit a thermal conductivity of at least 5 W/m*K. In some embodiments, the material is curable to a form-stable condition.

The liquid silicone resin may be present in an amount of between 4-20 wt. % of the potting material.

The thermally conductive particulate filler may be selected from aluminum oxide, silicon oxide, aluminum trihydrate, zinc oxide, graphite, magnesium oxide, aluminum nitride, boron nitride, metal particulate, and combinations thereof. In some embodiments, the thermally conductive particulate filler is one or more of aluminum nitride and aluminum oxide having an average particle size (d₅₀) of between 1-200 μm.

Another embodiment of the present invention includes a thermally conductive potting material having a liquid silicone resin, a dispersing agent comprising a copolymer of polysiloxane and an organic polymer, and thermally conductive particulate filler. The potting material exhibits a thermal conductivity of at least 3 W/m*K and a viscosity of less than 500 Ps*s at a first shear rate of 0.1 s⁻¹ and at 25° C., and a viscosity of less than 50 Pa*s at a second shear rate of 1 s⁻¹ and at 25° C.

In some embodiments, the thermally conductive particulate filler is present in an amount of at least 90 wt. % of the potting material, and the potting material exhibits a change in viscosity (Δρ) of less than 100 Pa*s between the first and second shear rates at 25° C.

In some embodiments, the liquid silicone is present in an amount of between 4-20 wt. % of the potting material, and the dispersing agent is present in an amount of between 0.1-2 wt. % of the potting material.

### BRIEF DESCRIPTION OF THE DRAWING

FIG. 1 is a chart comparing viscosities over shear rate ranges for the composition of the present invention and a comparative composition.

### DETAILED DESCRIPTION OF THE INVENTION

The objects and advantages enumerated above together with other objects, features, and advances represented by the present invention are now described in terms of detailed embodiments. Other embodiments and aspects of the invention, however, are recognized as being within the grasp of those having ordinary skill in the art.

The compositions of the present invention include a low viscosity liquid polymer matrix within which is dispersed thermally conductive particulate filler. Typical matrix materials useful in the present invention may be thermoplastic or thermoset polymers that may be blended with the particulated filler to form the thermally conductive potting material, most typically in the form of a liquid emulsion. Example polymers for forming the matrix include elastomers comprising one or more of a silicone, an acrylic, a natural rubber, a synthetic rubber, or other appropriate elastomeric materials.

In some embodiments, the matrix material includes a thermoplastic elastomer that is formed from a fluid resin having a viscosity of less than 500 cP at a shear rate of 1 s⁻¹ at 25° C. An example silicone polymer includes an organosiloxane having the structural formula:

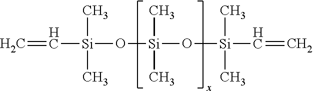

wherein “x” represents an integer ranging from between 1 and 100, and in some embodiments, from between 1 and 500. In some embodiments, the matrix material may be prepared as a reaction product of the organosiloxane together with a chain extender/cross-linker such as a hydride-functional polydimethyl siloxane having the structural formula:

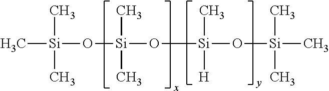

wherein “x” and “y” each represent an integer having a value of between 1 and 1,000, and in some embodiments between 1 and 500.

An example polymer matrix material of the present potting materials may comprise polyorganosiloxanes containing one or more, and in some embodiments, two or more alkenyl groups per molecule, each of the alkenyl groups being bonded to a silicon atom. The polyorganosiloxane may be of a straight-chain or branched structure, or mixtures thereof. Example alkenyl groups include vinyl, allyl, butenyl, and hexenyl. Examples of organic groups bonded to a silicon atom include linear alkyl groups, branched alkyl groups, cyclic alkyl groups, alkenyl groups, aryl groups, aralkyl groups, and halogenated alkyl groups.

The polymer matrix material may be curable to a form-stable condition, such as, for example, a gel-like or rubber-like cured product.

The polymer matrix material may preferably exhibit a viscosity, as measured at 25° C., of less than 500 cP at a shear rate of 1 s⁻¹. In some embodiments, the polymer matrix material may preferably exhibit a viscosity of between 1 and 500 cP at a shear rate of 1 s⁻¹ and at 25° C. As described herein, an aspect of the invention is to provide a flowable, highly thermally conductive potting material. The low viscosities of the contemplated polymer matrix materials aids in maintaining the pre-cure flowability of the present materials.

The polymer matrix material may be present in the thermally conductive potting materials of the present invention in an amount of between 1-20 wt. %. In some embodiments, the polymer matrix material is present in an amount of between 2-20 wt. % of the potting material. In some embodiments, the polymer matrix material is present in an amount of between 4-20 wt. % of the potting material. In some embodiments, the polymer matrix material is present in an amount of between 1-10 wt. % of the potting material. In some embodiments, the polymer matrix material is present in an amount of between 1-6 wt. % of the potting material. In some embodiments, the polymer matrix material is present in an amount of between 2-6 wt. % of the potting material. In a particular embodiment, the polymer matrix material is present in an amount of between 4-6 wt. % of the potting material.

Thermally conductive particulate filler is included in the materials of the present invention to impart thermal conductivity. The thermally conductive particulate filler may be dispersed in the polymer matrix material, and may be electrically conductive or electrically insulative, as the application demands. Example thermally conductive particles include aluminum oxide, silicon oxide, aluminum trihydrate, zinc oxide, graphite, magnesium oxide, aluminum nitride, boron nitride, metal particulate, such as aluminum, copper, and nickel, and combinations thereof.

The shape of the thermally conductive particulate filler may be spherical, aspherical, and combinations thereof. Example aspherical shapes include rod-like and plate-like. Spherical particulate filler may have an aspect ratio of between 0.8-1.2.

The average particle size of the thermally conductive particulate filler may range from between about 0.1-250 μm, typically between about 0.1-200 μm, and more commonly between about 0.2-200 μm. In some embodiments, the distribution of thermally conductive particulate filler is not a mono dispersion, but rather a particle size distribution. In some embodiments, the particle size distribution is multi-modal, including a mixture of relatively small particles and relatively large particles, within the size ranges described above. In some embodiments, at least one mode of the multi-modal particle size distribution includes an average particle size of between 110-180 μm. For the purposes hereof, the term “average particle size” refers to a cumulative weight average value (d₅₀) in which 50% of the particles are larger than the value, and 50% of the particles are smaller than the value, as determined by laser light diffraction.

The thermally conductive particulate filler is present in an amount sufficient to provide the potting material with a high degree of thermal conductivity. In some embodiments, the thermally conductive potting material exhibits a thermal conductivity of at least 3 W/m*K. In some embodiments, the thermally conductive potting material exhibits a thermal conductivity of at least 5 W/m*K. In some embodiments, the thermally conductive potting material exhibits a thermal conductivity of at least 7 W/m*K. The thermal conductivity of the potting material may be ascertained by ASTM 5470.

In order to achieve the high thermal conductivity values described above, the thermally conductive particulate filler may be present in an amount of at least 90 wt. % of the potting material. In some embodiments, the thermally conductive filler may be present in an amount of between 90-97 wt. % of the potting material. In some embodiments, the thermally conductive filler may be present in an amount of between 92-96 wt. % of the potting material.

The amount of thermally conductive filler present in the compositions of the present invention, while maintaining good flowability properties for the composition as a whole, represents an important aspect of the invention. A measure of thermally conductive filler loading relative to polymer matrix/resin may therefore illuminate a feature of the invention being high filler loading relative to polymer concentration. A typical measure is parts per hundred weight of the polymer resin (phr). In some embodiments, the thermally conductive particulate filler may be present in an amount of between 500 and 2500 parts by weight per 100 parts by weight of the polymer matrix material. In some embodiments, the thermally conductive particulate filler may be present in an amount of between 1000 and 2200 parts by weight per 100 parts by weight of the polymer matrix material. In some embodiments, the thermally conductive particulate filler may be present in an amount of between 1600 and 2000 parts by weight per 100 parts by weight of the polymer matrix material. In some embodiments, the polymer matrix material is polyorganosiloxane.

The thermally conductive potting material may further include a dispersing agent effective to facilitate the rheological properties of the potting material which includes the thermally conductive particulate filler in the amounts described above. In some embodiments, the dispersing agent may comprise an organopolysiloxane being a copolymer of a polysiloxane and an organic polymer. In some embodiments, the dispersing agent is an organopolysiloxane containing at least one silyl group and free of cyclic structures on the skeleton.

Applicant has found that use of the dispersing agent in amounts of between 0.1 and 2 wt. % of the potting material facilitates the unique rheological properties of the present invention. In some embodiments, the dispersing agent is present in an amount of between 0.1 and 1 wt. % of the potting material. In some embodiments, the dispersing agent is present in an amount of between 0.1 and 0.5 wt. % of the potting material. In some embodiments, the dispersing agent is present in an amount of between 0.2 and 0.4 wt. % of the potting material.

The thermally conductive potting materials of the present invention may further include a hydrosilylation reaction catalyst which is added in order to promote the cure of the composition, preferably a platinum group metal based catalyst. Suitable platinum group metal based catalysts include, for example, platinum based catalysts, rhodium based catalysts, iridium based catalysts, palladium based catalysts, and ruthenium based catalysts, with the platinum based catalysts being preferred.

In accordance with some embodiments of the present invention, the compositions described herein may further comprise one or more flow additives, adhesion promoters, rheology modifiers, toughening agents, fluxing agents, film flexibilizers, curing agents (catalysts, promoters, initiators, etc.), and the like, as well as mixtures of any two or more thereof.

As used herein, the term “flow additives” refers to compounds which modify the viscosity of the formulation to which they are introduced.

As used herein, the term “adhesion promoters” refers to compounds which enhance the adhesive properties of the formulation to which they are introduced.

As used herein, the term “toughening agents” refers to additives which enhance the impact resistance of the formulation to which they are introduced.

As used herein, the term “film flexibilizers” refers to agents which impart flexibility to the films prepared from formulations containing the same.

As used herein, the term “curing agents” refers to reactive agents which participate in or promote the curing of monomeric, oligomeric, or polymeric materials.

An aspect of the present invention is the rheological properties of the highly thermally conductive potting material. In particular, the potting material may preferably exhibit relatively low viscosities at both high and low shear rates, such that the material is both dispensable under high shear and self-leveling (liquid-like) at low shear. In other words, the change in viscosity (Δρ) is low over a broad range of shear. For the purposes hereof, the term “self-leveling” is intended to mean the property of settling under only the force of gravity to a shape having a substantially planar surface that is normal to the gravitational force.

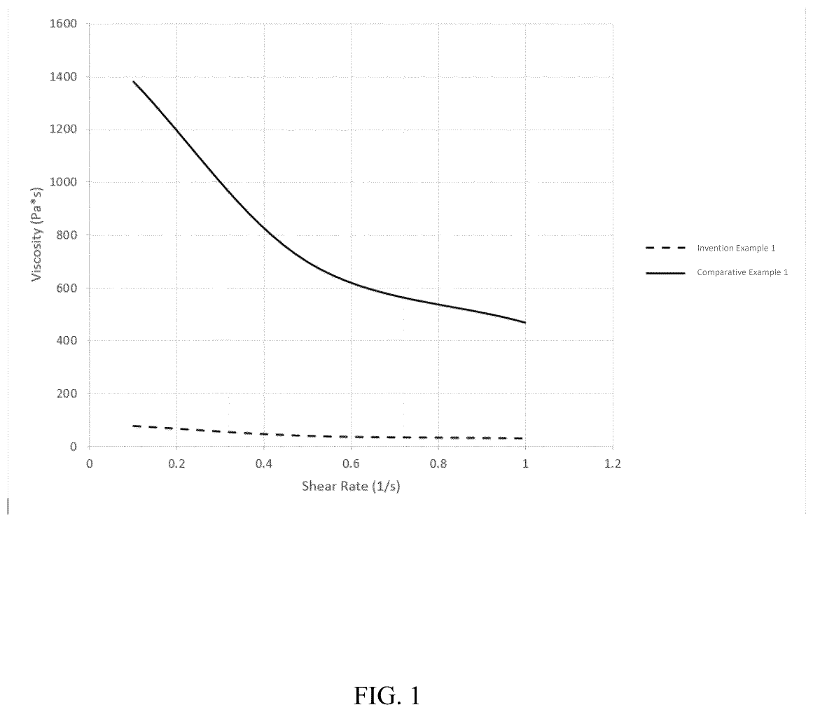

FIG. 1 contrasts the rheological properties of the invention with conventional highly-filled thermally conductive compositions. Both the “Invention Example 1” sample and the “Comparative Example 1” sample exhibit thermal conductivity in the range of about 8 W/m*K. However, the Δρ of Invention Example 1 is substantially less than the Δρ of Comparative Example 1 across a shear range of between 0.1 s⁻¹ and 1 s⁻¹. In some embodiments, the thermally conductive potting materials of the present invention exhibit a Δρ of less than 100 Pa*s between a first shear rate of 0.1 s⁻¹ and a second shear rate of 1.0 s⁻¹. In some embodiments, the thermally conductive potting materials of the present invention exhibit a Δρ of less than 80 Pa*s between a first shear rate of 0.1 s⁻¹ and a second shear rate of 1.0 s⁻¹.

The low Δρ property of the present compositions is especially valuable in combination with low absolute viscosities across shear ranges. In some embodiments, the potting material of the present invention exhibits a viscosity of less than 500 Pa*s at a first shear rate of 0.1 s⁻¹ and at 25° C., and a viscosity of less than 50 Pa*s at a second shear rate of 1 s⁻¹ and at 25° C. In some embodiments, the potting material of the present invention exhibits a viscosity of less than 250 Pa*s at a first shear rate of 0.1 s⁻¹ and at 25° C., and a viscosity of less than 50 Pa*s at a second shear rate of 1 s⁻¹ and at 25° C. In some embodiments, the potting material of the present invention exhibits a viscosity of less than 150 Pa*s at a first shear rate of 0.1 s⁻¹ and at 25° C., and a viscosity of less than 50 Pa*s at a second shear rate of 1 s⁻¹ and at 25° C. Table 1 below sets forth viscosity values for two present potting material compositions in contrast to comparative material compositions of similar thermal conductivity values:

TABLE 1

| | Critical | | | |
|---|---|---|---|---|
| | Stress | Viscosity @ | Viscosity @ | Viscosity @ |
| Sample | (Pa) | 0.1⁻¹(Pa · s) | 0.5⁻¹(Pa · s) | 1⁻¹(Pa · s) |
| Invention Ex. 1 | 0 | 76 | 38.4 | 28.9 |
| (8 W/m*K) | | | | |
| Invention Ex. 2 | 0 | 104.8 | 39 | 26.2 |
| (3 W/m*K) | | | | |
| Comp. Ex. 1 | 56 | 1378.4 | 696.9 | 468.1 |
| (8 W/m*K) | | | | |
| Comp. Ex. 2 | 100.1 | 2550.3 | 893.4 | 532.5 |
| (3 W/m*K) | | | | |

The viscosity values were measured on a Discovery HR-3 parallel plate rheometer, with a 25 mm aluminum upper plate and al aluminum peltier plate. Viscosity was measured at 25° C. with a gap of 1 mm following the method of a 5 second pre-shear at 1 s⁻¹ followed by a one minute equilibrium period, then a shear rate ramp of 0.1 to 1.1 s⁻¹ with a duration of 3 minutes. The sampling interval was 1 s/pt.

The potting material compositions of the present invention may further exhibit substantially zero critical stress. The critical stress of the compositions was measured using a parallel plate rheometer having a 25 mm upper plate at 25° C. and set to a 1 mm gap. An oscillatory amplitude sweep was performed on the samples from 10 μN*m torque to 150,000 μN*m torque at a frequency of 1 Hz, measuring 10 points per decade. The storage modulus is measured against the oscillation stress. The critical (yield) stress is measured at the x-axis value where tan δ=1.

### EXAMPLES

The following examples demonstrate effective thermal conductivity and viscosity values for various thermally conductive potting materials.

### Example 1

The following Table 2 describes the composition of the thermally conductive potting material.

TABLE 2

| MATERIAL | WEIGHT (PHR) |
|---|---|
| Polyorganosiloxane | 95 |
| Organically-modified Polysiloxane | 5 |
| Aluminum Oxide (d₅₀ = 10 μm ) | 400-800 |
| Aluminum Nitride (d₅₀ = 95 μm ) | 800-1600 |

The thermal conductivity for the material of Example 1 was 8.1 W/m*K, and the material exhibited a viscosity of 10 Pa*s at a shear rate of 0.5 s⁻¹ at 25° C.

### Example 2

The following Table 3 describes the composition of the thermally conductive potting material.

TABLE 3

| MATERIAL | WEIGHT (PHR) |
|---|---|
| Polyorganosiloxane | 95 |
| Organically-modified Polysiloxane | 5 |
| Aluminum Nitride (d₅₀ = 2 μm ) | 200-400 |
| Aluminum Oxide (d₅₀ = 85 μm ) | 1000-2000 |

The thermal conductivity for the material of Example 2 was 7.2 W/m*K, and the material exhibited a viscosity of 21 Pa*s at a shear rate of 0.5 s⁻¹ at 25° C.

1. A thermally conductive potting material, comprising:
a polymer matrix including a liquid silicone resin; and
thermally conductive particulate filler dispersed in the liquid silicone resin in an amount of at least 90 wt. % of the potting material,
wherein the potting material exhibits a thermal conductivity of at least 3 W/m*K and a viscosity of less than 500 Pa*s at a first shear rate of 0.1 s⁻¹ and at 25° C., and a second viscosity of less than 50 Pa*s at a second shear rate of 1 s⁻¹ and at 25° C.

2. Th thermally conductive potting material as in claim 1, exhibiting a viscosity of less than 50 Pa*s at a third shear rate of 0.5 s⁻¹ and at 25° C.

3. The thermally conductive potting material as in claim 1, exhibiting a Δρ of less than 100 Pa*s between the first and second shear rates at 25° C.

4. The thermally conductive potting material as in claim 1, exhibiting substantially zero critical stress.

5. The thermally conductive potting material as in claim 1, wherein the liquid silicone resin exhibits a viscosity of less than 500 cP at a shear rate of 1 s⁻¹ at 25° C.

6. The thermally conductive potting material as in claim 1, exhibiting a thermal conductivity of at least 5 W/m*K.

7. The thermally conductive potting material as in claim 1, being curable to a form-stable condition.

8. The thermally conductive potting material as in claim 1, including the liquid silicone resin in an amount of between 1-20 wt. % of the potting material.

9. The thermally conductive potting material as in claim 1, wherein the thermally conductive particulate filler is selected from aluminum oxide, silicon carbide, aluminum nitride, boron nitride, magnesium oxide, and combinations thereof.

10. The thermally conductive potting material as in claim 1, wherein the thermally conductive particulate filler is one or more of aluminum nitride and aluminum oxide having an average particle size (d₅₀) of between 1-200 μm.

11. The thermally conductive potting material as in claim 1, wherein the thermally conductive particulate filler is dispersed in the liquid silicone resin in an amount exceeding 1500 phr.

12. A thermally conductive potting material, comprising:
a liquid silicone resin having a viscosity of less than 500 cP at a shear rate of 1 s⁻¹ and at 25° C.;
a dispersing agent comprising a copolymer of polysiloxane and an organic polymer; and
thermally conductive particulate filler,
wherein the potting material exhibits a thermal conductivity of at least 3 W/m*K and a viscosity of less than 500 Pa*s at a first shear rate of 0.1 s⁻¹ and at 25° C., and a viscosity of less than 50 Pa*s at a second shear rate of 1 s⁻¹ and at 25° C.

13. The thermally conductive potting material as in claim 12, including the thermally conductive particulate filler in an amount of at least 90 wt % of the potting material.

12. The thermally conductive potting material as in claim 12, exhibiting a Δρ of less than 100 Pa*s between the first and second shear rates at 25° C.

15. The thermally conductive potting material as in claim 12, exhibiting essentially zero critical stress.

16. The thermally conductive potting material as in claim 12, exhibiting a thermal conductivity of at least 5 W/m*K.

17. The thermally conductive potting material as in claim 12, being curable to a form-stable condition.

18. The thermally conductive potting material as in claim 12, including the liquid silicone in an amount of between 1-20 wt. % of the potting material, and the dispersing agent in an amount of between 0.1-2 wt. % of the potting material.
